(19) United States
(12) Patent Application Publication
(10) Pub. No.: US 2024/0368784 A1
(43) Pub. Date: Nov. 7, 2024

(54) METHOD FOR MANUFACTURING A THIN FILM COMPOSITE MEMBRANE FOR ALKALINE WATER ELECTROLYSIS

(71) Applicant: KOREA UNIVERSITY RESEARCH AND BUSINESS FOUNDATION, Seoul (KR)

(72) Inventors: Jung Hyun LEE, Seoul (KR); Sung Kwon JEON, Bucheon-si (KR); Ju Yeon CHOI, Paju-si (KR); Han Soo KIM, Seongnam-si (KR)

(73) Assignee: KOREA UNIVERSITY RESEARCH AND BUSINESS FOUNDATION, Seoul (KR)

(21) Appl. No.: 18/561,598

(22) PCT Filed: May 16, 2022
(86) PCT No.: PCT/KR2022/006988

§ 371 Date: Nov. 16, 2023

(30) Foreign Application Priority Data
May 17, 2021 (KR) 10-2021-0063659
May 24, 2021 (KR) 10-2021-0066403

(51) Int. Cl. C25B 13/02; C25B 13/08

(52) U.S. Cl. CPC C25B 13/02; C25B 13/08

(57) ABSTRACT

The present invention relates to a method for manufacturing a thin film composite membrane for alkaline water electrolysis, and to a thin film composite membrane for alkaline water electrolysis. The present invention can provide a thin film composite membrane, which has excellent water electrolysis performance due to low mass transport resistance and high ion conductivity thereof compared to conventional nonporous membranes and porous membranes, and it is also highly safe by lowering gas permeability and minimizing gas mixing.

### TECHNICAL FIELD

The present invention relates to a method of manufacturing a thin film composite membrane for alkaline water electrolysis, and a thin film composite membrane for alkaline water electrolysis, which is manufactured using the method.

### BACKGROUND ART

A water electrolysis system is a method to obtain hydrogen through water electrolysis. An electrolyte solution is continuously supplied to each electrode, and hydrogen and oxygen gases are generated at the cathode and anode, respectively.

Alkaline water electrolysis refers to a water electrolysis technology that uses an alkaline electrolyte solution including hydroxide ions, and migration of hydroxide ions from the cathode to the anode completes the electrical circuit between both electrodes. Since the alkaline electrolyte is strongly basic, there is an advantage in that relatively inexpensive non-precious metal-based nickel (Ni) or silver (Ag) can be used as a catalyst.

In an alkaline water electrolysis process, a membrane is placed between both electrodes, which plays a key role in controlling the mass and ion transport between the electrodes. In order for the membrane to be efficiently applied to the alkaline water electrolysis system, it is necessary to have high hydroxide ion conductivity to lower the voltage load required during water electrolysis. In addition, since there is a risk of explosion when a concentration of hydrogen in oxygen increases to 4% or more, the membrane needs to have low permeability to hydrogen and oxygen gases generated at the cathode and the anode, respectively.

In conventional alkaline water electrolysis, a porous membrane was mainly used. As a typical commercially available alkaline water electrolysis membrane, there is Zirfon® from Agfa, Belgium, which is manufactured to have a porous structure by applying a solution of zirconium oxide (ZrO₂) nanoparticles/polysulfone on a polyphenylene sulfide support and performing phase inversion.

Zirfon® has the advantages of excellent alkaline stability and low mass transport resistance due to its porous structure. However, Zirfon® has high gas permeability due to its large average surface pore size (150 nm) and high porosity (55%), and thus, generated oxygen and hydrogen easily penetrate through the membrane, resulting in a high risk of explosion due to gas mixing. In addition, Zirfon® has a drawback of high area specific resistance because the distance between electrodes increases due to its thick (500 to 600 μm) structure.

Accordingly, in order to reduce the risk caused by the high gas permeability of conventional porous membranes, nonporous (high density) membranes with low gas permeability are being studied, but the nonporous membranes have high voltage loads due to their high mass transport resistance. In addition, their low mechanical strength and low thermochemical stability limit their operating conditions to mild conditions.

### DISCLOSURE

### Technical Problem

The present invention is for simultaneously solving the disadvantages of the existing porous membrane and nonporous membrane, and an objective of the present invention is to provide a thin film composite membrane that has increased mechanical strength and thermochemical stability, exhibits high ion conductivity while lowering mass transport resistance, and at the same time, minimizes gas mixing by reducing gas permeability during water electrolysis to secure safety.

### Technical Solution

The present invention provides a method of manufacturing a thin film composite membrane for alkaline water electrolysis, including forming a crosslinked quaternary ammonium polymer selective layer on a porous support or inside pores of the porous support through Menshutkin polymerization.

The present invention also provides a thin film composite membrane for alkaline water electrolysis, including: a porous support; and
a selective layer formed on one side, both sides, or inside the pores of the porous support,
wherein the selective layer is a crosslinked quaternary ammonium polymer in the form of being formed on the porous support or filling the pores of the porous support through Menshutkin polymerization.

The present invention additionally provides a method of manufacturing a thin film composite membrane for alkaline water electrolysis, including hydrophilizing a porous support, and a thin film composite membrane for alkaline water electrolysis, including the hydrophilized porous support.

### Advantageous Effects

The thin film composite membrane according to the present invention provides a thermochemically stable membrane for alkaline water electrolysis by hydrophilizing the porous support, and it has low mass transport resistance and high ion conductivity by coating an ion-conducting thin film selective layer on the porous support, so that it has excellent water electrolysis performance, and at the same time, it can prevent gas permeation and mixing by lowering gas permeability. Accordingly, it is possible to provide a thin film composite membrane capable of implementing an alkaline water electrolysis process having high safety and hydrogen production efficiency.

### BRIEF DESCRIPTION OF DRAWINGS

FIG. 1 is a schematic view showing a method of manufacturing a thin film composite membrane for alkaline water electrolysis utilizing Menshutkin polymerization.

FIG. 2 shows images of the surface structure of the porous support with a thickness of 20 μm, confirmed through a scanning electron microscope.

FIG. 3 shows images of the surface structure of the support before and after the hydrophilization of Example 2 according to Experimental Example 1, confirmed through a scanning electron microscope.

FIG. 4 shows images of the surface structures of the membranes of Examples 2 and 3 according to Experimental Example 1, confirmed through a scanning electron microscope.

FIG. 5 is a graph comparing voltage load values when operating a water electrolysis system in a 1 M potassium hydroxide solution according to Experimental Example 6.

FIG. 6 is a graph comparing voltage load values when operating a water electrolysis system in a 6 M potassium hydroxide solution according to Experimental Example 6.

FIG. 7 is a graph comparing voltage load values when operating a water electrolysis system in a 6 M potassium hydroxide solution according to Experimental Example 6.

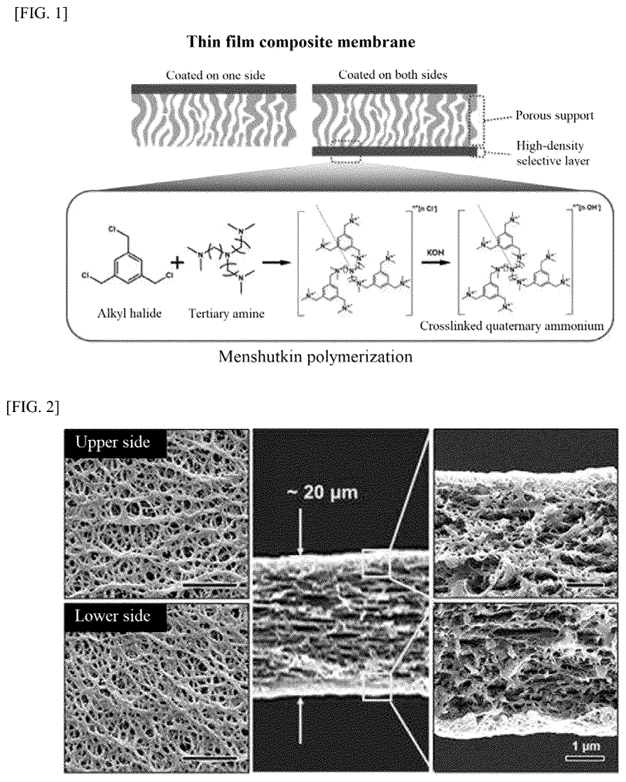

### BEST MODE FOR IMPLEMENTATION OF THE INVENTION

Hereinafter, the present invention will be described in more detail.

Meanwhile, each description and embodiment disclosed herein may also be applied to other descriptions and embodiments. That is, all combinations of the various elements disclosed herein are within the scope of the present invention. In addition, it cannot be said that the scope of the present invention is limited by the specific descriptions described below.

When a part is said to “include” a component, this means that other components may be further included, not excluded, unless specifically stated otherwise.

The present invention provides a method of manufacturing a thin film composite membrane utilizing Menshutkin polymerization.

Specifically, the present invention provides a method of manufacturing a thin film composite membrane for alkaline water electrolysis, including forming a quaternary ammonium polymer thin film selective layer on a porous support or inside pores of the porous support through Menshutkin polymerization.

The Menshutkin reaction is a reaction in which a tertiary amine and an alkyl halide react to form quaternary ammonium groups. The Menshutkin polymerization according to the present invention means to form a crosslinked quaternary ammonium polymer through the Menshutkin reaction. When a highly crosslinked quaternary ammonium polymer selective layer is formed on a porous support or inside pores of the porous support by Menshutkin polymerization, safety can be secured by lowering gas permeability, and it has strong alkaline stability and high ion conductivity, which may improve water electrolysis performance.

In the present invention, the porous support may be a polyolefin. A commercially available product may be used, or a porous support may be synthesized.

In one embodiment, as the porous support, one or more polymer components selected from the group consisting of polyethylene, polypropylene, polymethylpentene, polybutene-1, a polyolefin elastomer, polyisobutylene, ethylene propylene rubber, polysulfone, polyacetylene, polyisobutylene, polyvinyl chloride, Teflon (polytetrafluoroethylene), polyphenylene sulfide, polyacrylonitrile, polyethersulfone, polystyrene, polydimethylsiloxane, polyvinyl fluoride, ethylene vinyl alcohol, polyvinyl alcohol, polybenzimidazole, polyvinylpyrrolidone, polyetherimide, polyvinylidene fluoride, and polyetheretherketone may be used.

In one embodiment, the type of porous support is not particularly limited, but a polyolefin support such as polyethylene or polypropylene may be used.

In one embodiment, the weight average molecular weight of the porous polyolefin support may be 10,000 to 5,000,000 g mol⁻¹.

In one embodiment, the water contact angle of the porous polyolefin support may be 120 degrees or less.

In one embodiment, the porous polyolefin support may be prepared through a dry process based on a stretching process or a wet process based on an extraction process, and more preferably through the wet process.

In one embodiment, the porous polyolefin support may be prepared by melt-extruding a polymer constituting the support and a diluent, performing liquid-liquid phase separation to prepare a sheet form, and then stretching the sheet form. Here, the content of the diluent may be 10 to 80% by weight based on the total weight, and the diluent may be an aliphatic or cyclic hydrocarbon such as nonane, decane, paraffin oil, and decalin, or an organic liquid compound such as a phthalic acid ester, for example dibutyl phthalate or dioctyl phthalate.

When preparing the porous polyolefin support, general additives for improving specific functions, such as UV stabilizers, antistatic agents, oxidation stabilizers, and organic and inorganic nucleating agents, may be further included as needed.

In one embodiment, the pore size of the porous support is not particularly limited, but it may be 0.5 nm to 100 μm. Specifically, the pore size may be 10 μm or less, 1 μm or less, 500 nm or less, 200 nm or less, or 100 nm or less, and more specifically, 1 nm to 10 μm, 1 nm to 1 μm, or 1 to 100 nm.

In one embodiment, the porosity of the porous support is not particularly limited, but may be 0.5 to 90%, specifically 10 to 90%.

In one embodiment, the thickness of the porous support is not particularly limited, but it may be 1 to 1000 μm. More specifically, the thickness may be 1 to 100 μm, 1 to 50 μm, 3 to 40 μm, or 5 to 30 μm.

The manufacturing method of the present invention may further include hydrophilizing the porous support before forming the crosslinked quaternary ammonium polymer selective layer.

In the case of hydrophilization, hydrophilicity can be imparted to the hydrophobic porous support, hydroxide ion conductivity may be improved and gas permeability may be lowered. In addition, the formation of the selective layer may be facilitated.

The hydrophilization may be performed on one side, both sides, or the inner surface of the pores of the porous support.

The hydrophilization of the porous support may be performed by one or more of plasma, atomic layer deposition, chemical vapor deposition, inorganic coating, organic coating, and chemical oxidation treatment, more preferably organic coating treatment.

The organic coating may be a coating with an oligomer or polymer material including a hydrophilic functional group such as hydroxyl, carboxyl, or amine. For example, the organic coating may be a coating with one or more polymer components selected from the group consisting of polyvinyl alcohol, ethylene vinyl alcohol, polydopamine, polyacrylic acid, polymethacrylic acid, polyethylene glycol, polypropylene glycol, polyetherimide, tannic acid, polyvinyl amine, poly(4-styrene sulfonic acid), poly(vinylsulfonic acid), polyethylenimine, polyaniline, polyvinylpyrrolidone, and cellulose-based polymers.

In the hydrophilization, in order to increase the stability of the organic coating, crosslinking may be further included after coating with the organic material.

The crosslinking may be performed by utilizing one or more components selected from the group consisting of glyoxal, glutaraldehyde, epichlorohydrin, boric acid, maleic acid, citric acid, and tetraethyl orthosilicate.

In the present invention, a process of washing the porous support may be further included after the hydrophilization. As a washing solvent, isopropyl alcohol, water, or a mixed solvent thereof may be used.

The selective layer may be prepared on the hydrophilized porous support or inside the pores of the hydrophilized porous support through Menshutkin polymerization. The selective layer may be prepared on one side, both sides, or inside the pores of the porous support.

When the selective layer is formed inside the pores of the porous support, the selective layer inside the pores of the porous support may have a pore-filling form.

When the selective layer is formed on the porous support, the thickness of the selective layer may be 1 to 100 μm, 1 to 50 μm, 3 nm to 1 μm, 5 to 500 nm, or 5 to 200 nm.

The Menshutkin polymerization may be performed by an interfacial polymerization method, a dip coating method, a spin coating method, a layer-by-layer method, a slot coating method, or a spray coating method, more preferably the interfacial polymerization method.

The selective layer according to the present invention may be formed by impregnating or applying a first solution including tertiary amine-based monomers and a second solution including alkyl halide-based monomers into or on the porous support and performing a polymerization reaction between the monomers of the first solution and the second solution.

Here, in the impregnation or application of the first solution and the second solution, the first solution including tertiary amine-based monomers may be impregnated or applied first, and then the second solution including alkyl halide-based monomers may be impregnated or applied. Or vice versa, the second solution may be impregnated or applied first, and then the first solution may be impregnated or applied, alternatively, the first solution and the second solution may be simultaneously impregnated or applied.

A solvent of the first solution and a solvent of the second solution for the polymerization are different from each other and may exhibit a property of not mixing with each other.

The tertiary amine-based monomer is not particularly limited as long as it is a monomer including tertiary amine groups capable of forming a crosslinked quaternary ammonium polymer as a reactant of Menshutkin polymerization.

The tertiary amine-based monomer may include two or more tertiary amine groups. When two or more tertiary amine groups are included, a crosslinked polymer can be easily formed by reacting with alkyl halide monomers.

The tertiary amine-based monomer may have a molecular weight ranging from 50 to 1,000,000 g mol⁻¹.

The tertiary amine-based monomer may be at least one selected from the group consisting of N,N,N′,N′-tetramethylmethylenediamine, N,N,N′,N′-tetramethylethylenediamine, N,N,N′,N″,N″-pentamethyldiethylenetriamine, 1,1,4,7,10,10-hexamethyltriethylenetetramine, tris [2-(dimethylamino)ethyl]amine, tris(dimethylamino) methane, tetramethyl-1,3-diaminopropane, N,N,N′,N′-tetramethyl-1,4-butanediamine, N,N,N′,N′-tetramethyl-1,6-hexamethylenediamine, 1,4-dimethylpiperazine, 1,4,7-trimethyl-1,4,7-triazacyclononane, 1,4,8,11-tetramethyl-1,4,8,11-tetraazacyclotetradecane, N,N,N′,N′-tetramethyl-1,4-phenylenediamine, N,N,N′,N′-tetramethyl-1,3-phenylenediamine, 1,4-bis(diphenylamino)benzene, 4,4′-trimethylenebis(1-methylpiperidine), hexamine, altretamine, and polyethylenimine, most preferably N,N,N′,N″,N″-pentamethyldiethylenetriamine.

In one embodiment, the type of the solvent of the first solution including the tertiary amine-based monomer is not particularly limited, and for example, at least one selected from the group consisting of water, methanol, ethanol, propanol, butanol, isopropanol, ethyl acetate, acetone, chloroform, tetrahydrofuran, dimethyl sulfoxide, dimethyl phthalate, diethyl phthalate, dibutyl phthalate, dimethylformamide, N-methyl-2-pyrrolidone, acetophenone, and acetonitrile may be used. When the tertiary amine-based monomer is N,N,N′,N″,N″-pentamethyldiethylenetriamine, a preferred solvent for the first solution may be dimethyl phthalate.

The alkyl halide-based monomer is not particularly limited as long as it is a monomer including alkyl halide groups capable of forming a crosslinked quaternary ammonium polymer thin film as a reactant of Menshutkin polymerization.

The alkyl halide-based monomer may include two or more alkyl halide groups. When two or more alkyl halide groups are included, a crosslinked polymer may be easily formed by reacting with tertiary amine-based monomers.

The alkyl halide-based monomer may have a molecular weight ranging from 50 to 1,000,000 g mol⁻¹.

The alkyl halide-based monomer may be at least one selected from the group consisting of 1,2-dichloroethane, 1,3-dichloropropane, 1,3-dibromopropane, 1,4-dichlorobutane, 1,4-dibromobutane, 1,4-diiodobutane, 1,6-dichlorohexane, 1,2-bis(bromomethyl)benzene, 1,3-bis(bromomethyl)benzene, 1,4-bis(bromomethyl)benzene, 1,3,5-tris(bromomethyl)benzene, 2,6-bis(bromomethyl) naphthalene, and 1,4-bis(1,2-dibromoethyl)benzene, most preferably 1,3,5-tris(bromomethyl)benzene.

In one embodiment, the type of the solvent of the second solution including alkyl halide-based monomers is not particularly limited, and for example, at least one selected from the group consisting of n-hexane, pentane, cyclohexane, heptane, octane, decane, dodecane, tetrachloromethane, benzene, xylene, toluene, chloroform, tetrahydrofuran, N-methyl-2-pyrrolidone, acetophenone, acetonitrile, dimethyl phthalate, diethyl phthalate, dibutyl phthalate, dimethylformamide, and isoparaffin may be used. When the alkyl halide-based monomer is 1,3,5-tris(bromomethyl)benzene, n-hexane may be used as a preferred solvent for the second solution.

In one embodiment, when the miscibility of the solvent of the first solution and the solvent of the second solution is increased during interfacial polymerization, a thin film composite membrane in which the selective layer is in a form of filling the pores of the porous support may be manufactured.

The present invention also provides a thin film composite membrane including a porous support; and a selective layer formed on one side, both sides, or inside the pores of the porous support, wherein the selective layer is a crosslinked quaternary ammonium polymer in the form of being formed on the porous support or filling the pores of the porous support through Menshutkin polymerization.

The thin film composite membrane according to the present invention may be manufactured by the above-described method of manufacturing a thin film composite membrane. The thin film composite membrane according to the present invention may have high ion conductivity and low mass transport resistance to achieve high water electrolysis performance and low gas permeability to prevent gas mixing, thereby ensuring safety.

The contents of the thin film composite membrane of the present invention may be applied in the same manner as in the above-described contents of the method of manufacturing a thin film composite membrane.

In one embodiment, the porous support according to the present invention may be a hydrophilized porous support. The hydrophilization is as described above in the method of manufacturing a thin film composite membrane.

In addition, the present invention provides a method of manufacturing a thin film composite membrane for alkaline water electrolysis, including hydrophilizing a porous support.

Here, the description of the hydrophilization and the porous support may be applied in the same manner as described above in the method of manufacturing a thin film composite membrane utilizing Menshutkin polymerization.

Even without a selective layer, when only the porous support is hydrophilized, superior water electrolysis performance, low gas permeability, and high safety may be achieved compared to a commercially available porous membrane.

The hydrophilization may be performed by organic coating. The organic coating is easy to form because a hydrophobic part of the hydrophilic polymer is bonded to a porous support through a hydrophobic interaction.

In one embodiment, the porous support is a polyolefin, and the hydrophilization may be performed by coating ethylene vinyl alcohol on the polyolefin.

The present invention also provides a thin film composite membrane for alkaline water electrolysis, including the hydrophilized porous support. Such a thin film composite membrane may be manufactured by a method including hydrophilizing the porous support. In addition, the description of the hydrophilization and the porous support may be applied in the same manner as described above in the method of manufacturing a thin film composite membrane utilizing Menshutkin polymerization.

Hereinafter, preferred Examples and Experimental Examples are presented to aid understanding of the present invention. However, the following Examples and Experimental Examples are only provided to more easily understand the present invention, and the content of the present invention is not limited by the following Examples and Experimental Examples.

### EXAMPLES

### Material Selection

(1) Porous support: Porous polyethylene supports prepared by a wet process were used. Their structures were similar, and a polyethylene support with a thickness of 9 μm (surface pore size <100 nm, porosity 51%) and a polyethylene support with a thickness of 20 μm (surface pore size <100 nm, porosity 47%) were prepared.

FIG. 2 shows a cross-sectional view of a polyethylene support with a thickness of 20 μm; the structures of the front and back surfaces of the polyethylene support are similar, and the support has a cross-sectional structure that is uniform and has excellent pore connectivity.

(2) Material for hydrophilization: Ethylene vinyl alcohol was used as a hydrophilic coating material for the support, and isopropanol and water were used as solvents for dissolving the hydrophilic coating material.

(3) Menshutkin polymerization monomers and solvents for preparing the selective layer: Interfacial polymerization, which is a polymerization reaction between monomers dissolved in two immiscible solvents, was utilized. Dimethyl phthalate and n-hexane were used as the solvents, N,N,N′,N″,N″-pentamethyldiethylenetriamine was used as a tertiary amine-based monomer, and 1,3,5-tris(bromomethyl)benzene was used as an alkyl halide-based monomer.

(4) Comparative Examples 1 and 2

In Comparative Example 1, Agfa's Zirfon® membrane, which is a commercially available porous membrane, was prepared.

In Comparative Example 2, Fumatech's FAA-3-50 membrane, which is a commercially available nonporous membrane, was prepared.

### Preparation Example 1. Preparation of the Support of Example 1

The support of Example 1 was prepared through the following step (1).

### (1) Hydrophilization of the Porous Support

Ethylene vinyl alcohol was dissolved by heating at 80° C. at a concentration of 0.5 g L⁻¹ in a solvent mixture of isopropanol and water with an equivolume ratio, and then cooled to 25° C. A polyethylene support with a thickness of 9 μm (surface pore size <100 nm, porosity 51%) was immersed in the prepared solution for 24 hours. After immersion, the support was washed with water to remove a residual solvent and dried in an oven at 90° C. for 1 hour.

### Preparation Example 2. Preparation of the Support of Example 2

The support of Example 2 was prepared in the same manner as Example 1, except that the polyethylene support in the preparation of Example 1 according to Preparation Example 1 was changed to a polyethylene support with a thickness of 20 μm (surface pore size <100 nm, porosity 47%).

### Preparation Example 3. Preparation of the Membrane of Example 3

In addition to Preparation Example 2, the membrane of Example 3 was prepared through the following step (2).

### (2) Formation of the Selective Layer on the Porous Support Using Menshutkin Interfacial Polymerization

A dense thin film selective layer was synthesized on the previously prepared hydrophilized porous polyethylene support using Menshutkin interfacial polymerization.

1) N,N,N′,N″,N″-pentamethyldiethylenetriamine was dissolved in a dimethyl phthalate solvent at 100 g L⁻¹, and then the hydrophilized polyethylene support was immersed therein for 1 hour.

2) After the immersed support was taken out, the excess solution on the surface was appropriately removed with a roller, and then it was immersed in a solution of 1,3,5-tris(bromomethyl)benzene dissolved in n-hexane at 2 g L⁻¹ and reacted at 25° C. for 24 hours.

3) After the reaction, the membrane was taken out, and the solution remaining on the surface was washed with n-hexane and dried at 25° C. for 5 minutes.

4) In order to further crosslink unreacted monomers, they were reacted in an oven at 70° C. for 5 minutes.

5) After that, it was immersed in a 1 M potassium hydroxide solution for 1 hour or more to exchange the bromide ions (Br) generated by the reaction with hydroxide ions (OH⁻).

### Experimental Example 1. Observation of Support/Membrane Surfaces

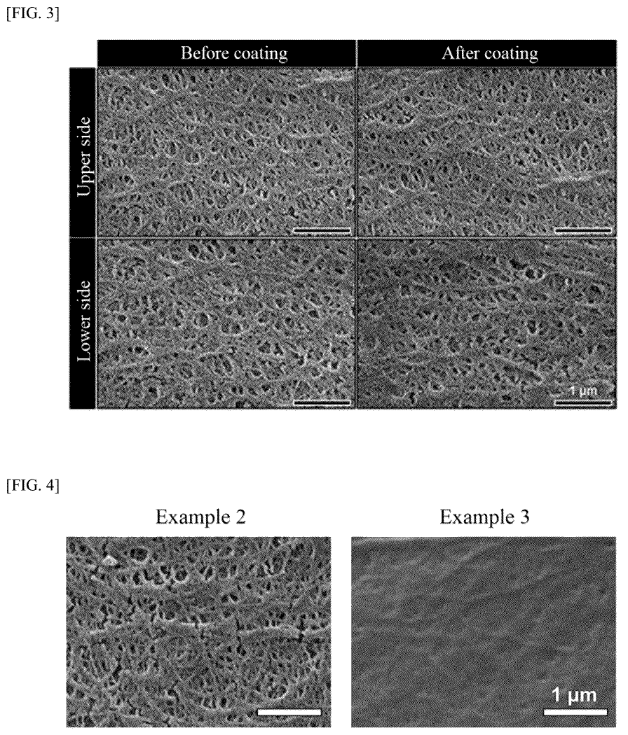

The surface of the support of Example 2 prepared in Preparation Example 2 was confirmed through a scanning electron microscope, and it was confirmed at various positions and shown in FIG. 3.

As can be seen in FIG. 3, it can be confirmed that the porous structure of the polyethylene support was maintained even after the hydrophilic coating. In particular, the surface pore size of the hydrophilized polyethylene support was about 100 nm or less, and it was smaller than the surface pore size (about 150 nm) of Comparative Example 1, which is a commercially available Zirfon® membrane, so that it was expected that gas permeation can be lowered.

Meanwhile, the surface of the membrane of Example 3 prepared in Preparation Example 3 was confirmed through a scanning electron microscope, and it was confirmed at various positions and shown in FIG. 4. As can be seen in FIG. 4, when synthesizing a selective layer on the hydrophilic porous support, it can be confirmed that a thin film composite structure was formed because the surface pore structure was blocked.

### Experimental Example 2. Confirmation of Hydrophilicity of Supports

The hydrophilicity of the polyethylene support before and after the hydrophilic coating using ethylene vinyl alcohol in Preparation Examples 1 and 2 was confirmed through the water contact angle, and the results are shown in Table 1 below.

TABLE 1

| | |
|---|---|
| Example 1 | Example 2 |
| (Thickness 9 μm) | (Thickness 20 μm) |

| | Before | After | Before | After |
|---|---|---|---|---|
| | coating | coating | coating | coating |
| Water contact | 113 | 47 | 119 | 55 |
| angle (°) | | | | |

As can be seen in Table 1, in both the polyethylene supports of Examples 1 and 2 with different thicknesses of 9 μm and 20 μm, the water contact angles were significantly lowered after coating with ethylene vinyl alcohol, and it can confirm that hydrophilicity was improved through the coating.

### Experimental Example 3. Gas Permeation Characteristics

Dissolved hydrogen permeability was measured to evaluate the gas permeability characteristics of Examples 1 to 3 and Comparative Example 1. The dissolved hydrogen permeability was evaluated using water permeance, and the water permeance was measured using a dead-end cell equipment at 25° C. using deionized water as a feed solution.

Specifically, the water permeance was calculated by measuring an amount of deionized water permeated at a measured pressure (differential pressure), and assuming that deionized water was saturated with hydrogen gas. Dissolved hydrogen permeability was calculated, and the results are shown in Table 2 below.

TABLE 2

| | | | Example 3 | Comparative |
|---|---|---|---|---|
| | Example 1 | Example 2 | (Thin film | Example 1 |
| | (Thickness | (Thickness | composite | (Zirfon ® |
| | 9 μm) | 20 μm) | membrane) | membrane) |
| Dissolved | 7.8 × | 7.9 × | 4.3 × | 6.8 × |
| hydrogen | 10⁻¹⁴ | 10⁻¹⁴ | 10⁻¹⁵ | 10⁻¹⁰ |
| permeability | | | | |
| (mol cm⁻¹ s⁻¹ bar⁻¹) | | | | |

As can be seen in Table 2, it can be confirmed that the support or thin film composite membrane of Examples 1 to 3 has very low dissolved hydrogen permeability compared to that of Comparative Example 1, which is a commercially available porous membrane (Zirfon®). Through this result, it was confirmed that, when the polyethylene support or the support-based thin film composite membrane is applied to a water electrolysis system, safety can be secured due to low gas permeability, and that gas does not permeate well even in low-load operation, so that it can operate flexibly in response to load fluctuations.

### Experimental Example 4. Area Specific Resistance Measurement

The area specific resistance of Examples 1 to 3 and Comparative Example 1 was measured by impedance spectroscopy using an H-type electrolysis cell. A 2 M potassium hydroxide solution at 25° C. was used as an alkaline electrolyte. The measured area specific resistance is shown in Table 3 below.

TABLE 3

| | | | Example 3 | Comparative |
|---|---|---|---|---|
| | Example 1 | Example 2 | (Thin film | Example 1 |
| | (Thickness | (Thickness | composite | (Zirfon ® |
| | 9 μm) | 20 μm) | membrane) | membrane) |
| Area specific | 61 | 68 | 68 | 379 |
| resistance | | | | |
| (mOhm cm²) | | | | |

As can be seen in Table 3, it can be confirmed that the support or thin film composite membrane of Examples 1 to 3 of the present invention has very low area specific resistance compared to that of Comparative Example 1, which is a commercially available porous membrane (Zirfon®). Through this result, when the polyethylene support or the support-based thin film composite membrane is applied to a water electrolysis system, it is possible to operate the water electrolysis system efficiently due to the low area specific resistance.

### Experimental Example 5. Mechanical Strength Measurement

The mechanical strength of Examples 2 and 3 and Comparative Examples 1 and 2 was measured using a universal testing machine. The mechanical strength was measured by stretching a support or membrane having an area of 75 mm² (5 mm×15 mm) at a rate of 20 mm min⁻¹ while wet with deionized water, and the measured mechanical strength is shown in Table 4 below.

TABLE 4

| | | Example 3 | Comparative | Comparative |
|---|---|---|---|---|
| | Example 2 | (Thin film | Example 1 | Example 2 |
| | (20 μm-thick | composite | (Zirfon ® | (FAA-3-50 |
| | support) | membrane) | membrane) | membrane) |
| Young's | 628 | 593 | 62 | 25 |
| modulus (MPa) | | | | |
| Tensile | 141 | 145 | 23 | 10 |
| strength (MPa) | | | | |
| Elongation (%) | 137 | 143 | 62 | 119 |

As can be seen in Table 4, it can be confirmed that the support or thin film composite membrane of Examples 2 and 3 of the present invention have higher mechanical strength than Comparative Example 1, which is a commercially available porous membrane (Zirfon®), and Comparative Example 2, which is a commercially available nonporous membrane (FAA-3-50). Through this result, when the polyethylene support or the support-based thin film composite membrane is applied to a water electrolysis system, it is possible to secure dimensional stability due to high mechanical strength, enabling stable water electrolysis system operation.

### Experimental Example 6. Voltage Load Characteristics

The performance of Examples 1 to 3 and Comparative Examples 1 and 2 was evaluated by measuring voltage according to current.

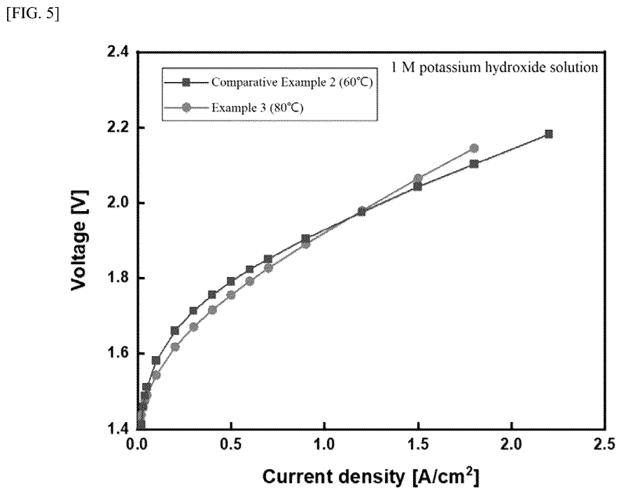

Specifically, measurement was made using a load cell that has an active area of 20 cm² and can evaluate performance while maintaining a constant clamping pressure (200 kgf), and 1 M (commercially available nonporous membrane measurement conditions) and 6 M (commercially available porous membrane measurement conditions) potassium hydroxide solutions at 80° C. were used as an electrolyte. As an electrode catalyst, Raney nickel was used as a cathode and nickel-iron layered double hydroxide was used as an anode. In addition, a porous nickel foam (110 ppi) was used as an electrode support, and a nickel current collector having a straight channel was applied. First, the performance of Example 3 and the performance of Comparative Example 2 were compared when the water electrolysis system operated at 80° C. in a 1 M potassium hydroxide solution. Here, Comparative Example 2 has low thermochemical stability and is decomposed at 80° C., so the performance of Comparative Example 2 was measured at 60° C., and Example 3 was measured at 80° C. as it was, and the results are shown in FIG. 5.

As can be seen in FIG. 5, Example 3 showed a similar voltage load value to that of Comparative Example 2 at the same current density. In addition, unlike Comparative Example 2, which decomposed at 80° C., Example 3 was able to operate at 80° C. and exhibited water electrolysis efficiency similar to that of Comparative Example 2 at a lower temperature (60° C.).

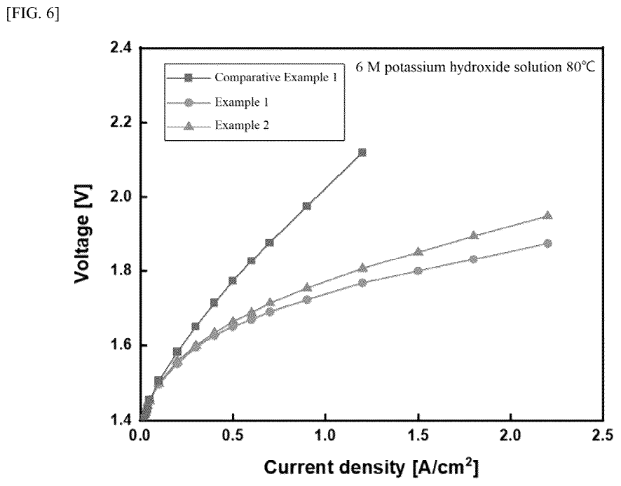

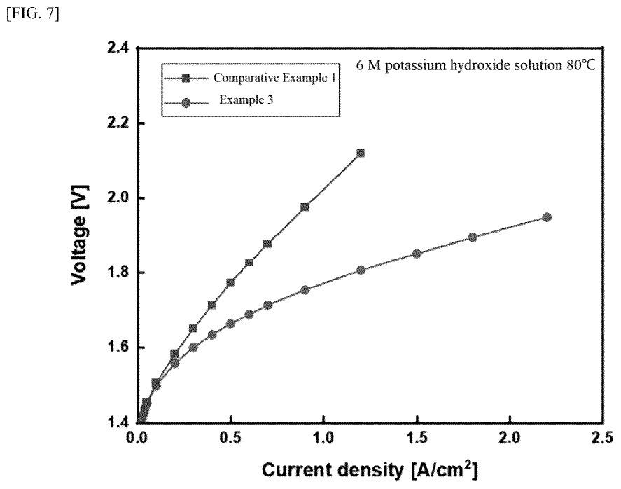

Meanwhile, the performances of Examples 1 to 3 and Comparative Example 1 were compared when the water electrolysis system operated at 80° C. in a 6 M potassium hydroxide solution, and the results are shown in FIGS. 6 and 7. As can be seen in FIGS. 6 and 7, it can be confirmed that Examples 1 to 3 showed a lower voltage load value than Comparative Example 1 at the same current density, which indicates that all of Examples 1 to 3 may have a higher water electrolysis efficiency than Comparative Example 1.

Through this result, when the polyethylene support or the support-based thin film composite membrane is applied to a water electrolysis system, it can operate under various operating conditions, and high hydrogen production efficiency can be expected.

1. A method of manufacturing a thin film composite membrane for alkaline water electrolysis, comprising forming a crosslinked quaternary ammonium polymer selective layer on a porous support or inside the pores of the porous support through Menshutkin polymerization.

2. The method of claim 1, wherein the porous support includes one or more polymer components selected from the group consisting of polyethylene, polypropylene, polymethylpentene, polybutene-1, a polyolefin elastomer, polyisobutylene, ethylene propylene rubber, polysulfone, polyacetylene, polyisobutylene, polyvinyl chloride, Teflon (polytetrafluoroethylene), polyphenylene sulfide, polyacrylonitrile, polyethersulfone, polystyrene, polydimethylsiloxane, polyvinyl fluoride, ethylene vinyl alcohol, polyvinyl alcohol, polybenzimidazole, polyvinylpyrrolidone, polyetherimide, polyvinylidene fluoride, and polyetheretherketone.

3. The method of claim 1, comprising hydrophilizing the porous support before forming the crosslinked quaternary ammonium polymer selective layer.

4. The method of claim 3, wherein the hydrophilization of the porous support is performed by one or more of plasma, atomic layer deposition, chemical vapor deposition, inorganic coating, organic coating, and chemical oxidation treatment.

5. The method of claim 4, wherein the hydrophilization of the porous support is an organic coating treatment, and
The organic coating is a coating with one or more polymer components selected from the group consisting of polyvinyl alcohol, ethylene vinyl alcohol, polydopamine, polyacrylic acid, polymethacrylic acid, polyethylene glycol, polypropylene glycol, polyetherimide, tannic acid, polyvinyl amine, poly(4-styrene sulfonic acid), poly(vinylsulfonic acid), polyethylenimine, polyaniline, polybenzimidazole, polyvinylpyrrolidone, and cellulose-based polymers.

6. The method of claim 5, wherein the organic coating treatment includes coating an organic material and then crosslinking the coated organic material.

7. The method of claim 1, wherein the Menshutkin polymerization is performed by an interfacial polymerization method, a dip coating method, a spin coating method, a layer-by-layer method, a slot coating method, or a spray coating method.

8. The method of claim 1, wherein the selective layer is formed by impregnating or applying a first solution including tertiary amine-based monomers and a second solution including alkyl halide-based monomers into or on the porous support and performing a polymerization reaction between the monomers of the first solution and the second solution.

9. The method of claim 8, wherein the tertiary amine-based monomer includes two or more tertiary amine groups, and/or the alkyl halide-based monomer includes two or more alkyl halide groups.

10. The method of claim 8, wherein the tertiary amine-based monomer is one or more selected from the group consisting of N,N,N′,N′-tetramethylmethylenediamine, N,N,N′,N′-tetramethylethylenediamine, N,N,N′,N″,N″-pentamethyldiethylenetriamine, 1,1,4,7,10,10-hexamethyltriethylenetetramine, tris [2-(dimethylamino)ethyl]amine, tris(dimethylamino) methane, tetramethyl-1,3-diaminopropane, N,N,N′,N′-tetramethyl-1,4-butanediamine, N,N,N′,N′-tetramethyl-1,6-hexamethylenediamine, 1,4-dimethylpiperazine, 1,4,7-trimethyl-1,4,7-triazacyclononane, 1,4,8,11-tetramethyl-1,4,8,11-tetraazacyclotetradecane, N,N,N′,N′-tetramethyl-1,4-phenylenediamine, N,N,N′,N′-tetramethyl-1,3-phenylenediamine, 1,4-bis(diphenylamino)benzene, 4,4′-trimethylenebis(1-methylpiperidine), hexamine, altretamine, and polyethylenimine.

11. The method of claim 8, wherein a solvent of the first solution is one or more selected from the group consisting of water, methanol, ethanol, propanol, butanol, isopropanol, ethyl acetate, acetone, chloroform, tetrahydrofuran, dimethyl sulfoxide, dimethyl phthalate, diethyl phthalate, dibutyl phthalate, dimethylformamide, N-methyl-2-pyrrolidone, acetophenone, and acetonitrile.

12. The method of claim 8, wherein the alkyl halide-based monomer is one or more selected from the group consisting of 1,2-dichloroethane, 1,3-dichloropropane, 1,3-dibromopropane, 1,4-dichlorobutane, 1,4-dibromobutane, 1,4-diiodobutane, 1,6-dichlorohexane, 1,2-bis(bromomethyl)benzene, 1,3-bis(bromomethyl)benzene, 1,4-bis(bromomethyl)benzene, 1,3,5-tris(bromomethyl)benzene, 2,6-bis(bromomethyl) naphthalene, and 1,4-bis(1,2-dibromoethyl)benzene.

13. The method of claim 8, wherein a solvent of the second solution is one or more selected from the group consisting of n-hexane, pentane, cyclohexane, heptane, octane, decane, dodecane, tetrachloromethane, benzene, xylene, toluene, chloroform, tetrahydrofuran, N-methyl-2-pyrrolidone, acetophenone, acetonitrile, dimethyl phthalate, diethyl phthalate, dibutyl phthalate, dimethylformamide, and isoparaffin.

14. A thin film composite membrane for alkaline water electrolysis, comprising:
a porous support; and
a selective layer formed on one side, both sides, or inside the pores of the porous support,
wherein the selective layer is a crosslinked quaternary ammonium polymer in the form of being formed on the porous support or filling the pores of the porous support through Menshutkin polymerization.

15. The thin film composite membrane of claim 14, wherein the porous support is the hydrophilized porous support.

16. A method of manufacturing a thin film composite membrane for alkaline water electrolysis, comprising hydrophilizing a porous support.

17. The method of claim 16, wherein the porous support is a polyolefin, and the hydrophilization is performed by coating the polyolefin with ethylene vinyl alcohol.

18. A thin film composite membrane for alkaline water electrolysis, comprising the hydrophilized porous support according to claim 16.
